(19) United States
(12) Patent Application Publication
(10) Pub. No.: US 2009/0274951 A1
(43) Pub. Date: Nov. 5, 2009

(54) NONAQUEOUS ELECTROLYTE SECONDARY BATTERY AND METHOD FOR PRODUCING THE SAME

(76) Inventors: Masahiro Kinoshita, Osaka (JP); Masaya Ugaji, Osaka (JP); Yoshiyuki Muraoka, Osaka (JP)

Correspondence Address: MCDERMOTT WILL & EMERY LLP, 600 13TH STREET, NW, WASHINGTON, DC, 20005-3096, US

(21) Appl. No.: 12/428,760

(22) Filed: Apr. 23, 2009

(30) Foreign Application Priority Data
Apr. 30, 2008 (JP) 2008-118144

(51) Int. Cl. H01M 6/10; H01M 4/82

(52) U.S. Cl. 429/94; 29/623.1

(57) ABSTRACT

A nonaqueous electrolyte secondary battery includes an electrode group in which a positive electrode plate including a positive electrode active material formed on a positive electrode current collector and a negative electrode plate including a negative electrode active material formed on a negative electrode current collector are wound with a separator interposed therebetween, and a tensile elongation rate of the positive electrode plate is larger than a tensile elongation rate of the negative electrode plate.

### CROSS-REFERENCE TO RELATED APPLICATION

This application claims priority from Japanese Patent Application No. 2008-118144 filed on Apr. 30, 2008, the disclosure of which application is hereby incorporated by reference into this application in its entirety for all purposes.

### BACKGROUND OF THE INVENTION

The present invention relates to a nonaqueous electrolyte secondary battery in which a high capacity material such as silicon or the like is used as a negative electrode active material, and a method for producing the nonaqueous electrolyte secondary battery.

Currently, a practical capacity of graphite which is generally used as a negative electrode active material for nonaqueous electrolyte secondary batteries is now about 350 mAh/g, which is very close to a theoretical capacity (372 mAh/g) of graphite. To realize a high capacity battery which can be used even with the increasing sophistication of mobile devices and the like, a negative electrode active material having a further increased capacity is demanded.

In this situation, increasing attention has been drawn to silicon (Si), tin (Sn), and a compound of silicon (Si) or tin (Sn) as a high capacity material. These elements can electrochemically insert and extract lithium ions, and are capable of performing charge/discharge with a very large capacity, compared to graphite. For example, it has been known that silicon has a high theoretical capacity, i.e., 4199 mAh/g, which is 11 times as large as a capacity of graphite.

However, since a negative electrode active material made of such a high capacity material largely expands/contracts due to charging/discharging, fall-off of the negative electrode active material, buckling deformation of an electrode plate, and the like occur, thus resulting in deterioration of its cycle life characteristic.

To avoid this problem, Japanese Published Patent Application No. 2002-313319 describes a technique in which a thin film of silicon or the like is formed on a current collector with a rough surface by sputtering, thereby obtaining an active material thin film having separate columnar portions on its surface. According to the technique, gaps are provided in the active material thin film and thus stress generated due to expansion/contraction of the active material thin film can be absorbed.

Japanese Published Patent Application No. 2003-007305 describes a technique in which a material having a predetermined tensile strength and a predetermined elastic coefficient is used as a negative electrode current collector. According to the technique, deformation of the current collector can be suppressed even when the current collector is subjected to stress due to expansion/contraction of an active material.

### SUMMARY OF THE INVENTION

However, in a battery in which an electrode group having a flat, wound structure is put in a rectangular battery case, even when a negative electrode active material or a negative electrode current collector is provided with the above-described function of reducing stress, it might not be possible to avoid the occurrence of buckling deformation in a flat portion of the electrode group along a length direction of the electrode group. This is probably because curved portions at both sides of the electrode group along the length direction are restricted in a constricted state by a battery case and thus stress can not be reduced in entire portions of the electrode group along the length direction. As a result, buckling deformation occurs in the flat portion between the curved portions.

One of the present inventors found, in examining causes of the occurrence of an internal short-circuit in a nonaqueous electrolyte secondary battery when the battery was crushed by application of an external pressure, that of a positive electrode plate, a negative electrode plate and a separator together constituting an electrode group, the positive electrode having the smallest tensile elongation rate was fractured preferentially and, as a result, fractured part of the positive electrode plate broke through the separator, thus causing a short-circuit of the positive electrode plate and the negative electrode plate.

Then, as a result of an examination of methods for increasing the tensile elongation rate of the positive electrode plate, it was further found that the effect of increasing the tensile elongation rate of the positive electrode plate could be achieved by performing heat treatment at a predetermined temperature after rolling of a positive electrode current collector to which a positive electrode mixture layer was applied.

Based on the foregoing findings, one of the present inventors disclosed in the patent application specification of Japanese Patent Application No. 2007-323217 (PCT/JP2008/002114) a method for suppressing the occurrence of an internal short-circuit in a nonaqueous electrolyte secondary battery crushed due to application of a pressure by setting a tensile elongation rate of a positive electrode plate to be a predetermined value or larger.

In contrast to known measures to suppress the occurrence of buckling deformation in an electrode group due to expansion/contraction of an negative electrode active material which have been taken only at the negative electrode side in most cases, the present inventors focused on a positive electrode side and examined the relationship between a positive electrode plate and the occurrence of buckling deformation of an electrode group. As a result, the present inventors found that the effect of suppressing the occurrence of buckling deformation in an electrode group due to expansion/contraction of a negative electrode active material could be achieved by setting a tensile elongation rate of a positive electrode plate to be larger than a tensile elongation rate of a negative electrode plate, and reached the present invention.

This Summary is provided to introduce a selection of concepts in a simplified form that are further described below in the Detailed Description. It is not intended to identify key features of the claimed subject matter, nor is it intended to be used as an aid in determining the scope of the claimed subject matter.

The invention disclosed and claimed herein, in one aspect thereof, comprises a nonaqueous electrolyte secondary battery comprising an electrode group in which a positive electrode plate including a positive electrode active material formed on a positive electrode current collector and a negative electrode plate including a negative electrode active material formed on a negative electrode current collector are wound with a separator interposed therebetween, and wherein a tensile elongation rate of the positive electrode plate is larger than a tensile elongation rate of the negative electrode plate.

With this configuration, the occurrence of buckling deformation in the electrode group due to expansion/contraction of the negative electrode active material can be suppressed even when a high capacity material is used as the negative electrode active material. Thus, a nonaqueous electrolyte secondary battery having excellent cycle life property can be realized.

In this configuration, the tensile elongation rate of the positive electrode plate is preferably within a range of 3% to 10%.

In one preferred embodiment of the present invention, after the positive electrode current collector with a positive electrode mixture slurry containing the positive electrode active material, applied thereto and dried is rolled, the positive electrode plate is subjected to heat treatment at a predetermined temperature.

In this case, the predetermined temperature is 200° C. or more.

In another preferred embodiment of the present invention, the negative electrode active material is formed of silicon, tin or a compound of silicon or tin.

In still another preferred embodiment of the present invention, the electrode group is wound into a flat shape and is placed in a rectangular battery case.

In this case, a flat portion of the flat electrode group is preferably subjected to pressure treatment with a pressure of 1×10⁵ N/m² or more at least at a time of an initial charge/discharge.

A method for producing a nonaqueous electrolyte secondary battery according to the disclosure of the present invention is a method for producing a nonaqueous electrolyte secondary battery including an electrode group in which a positive electrode plate including a positive electrode active material formed on a positive electrode current collector and a negative electrode plate including a negative electrode active material formed on a negative electrode current collector are wound with a separator interposed therebetween, and is characterized in that the positive electrode plate is formed by the steps of: applying a positive electrode mixture slurry containing a positive electrode active material to the positive electrode current collector and drying the slurry; rolling the positive electrode current collector with the positive electrode mixture slurry applied thereto and dried; and performing heat treatment to the rolled positive electrode current collector at a predetermined temperature, and a tensile elongation rate of the positive electrode plate is larger than a tensile elongation rate of the negative electrode plate.

In one preferred embodiment of the present invention, in the step of performing heat treatment, the rolled positive electrode current collector is subjected to heat treatment at a temperature of 200° C. or more.

In another preferred embodiment of the present invention, the electrode group is wound into a flat shape and is placed in a rectangular battery case.

### BRIEF DESCRIPTION OF THE DRAWINGS

FIG. 1 is a partial cutaway perspective view illustrating a configuration of a nonaqueous electrolyte secondary battery according to an embodiment of the present invention.

FIG. 2 is a graph showing the relationship between heat treatment temperature and tensile elongation rate.

### DETAILED DESCRIPTION

Hereinafter, embodiments of the present invention will be described with reference to the accompanying drawings. Note that the present invention is not limited to the following embodiments.

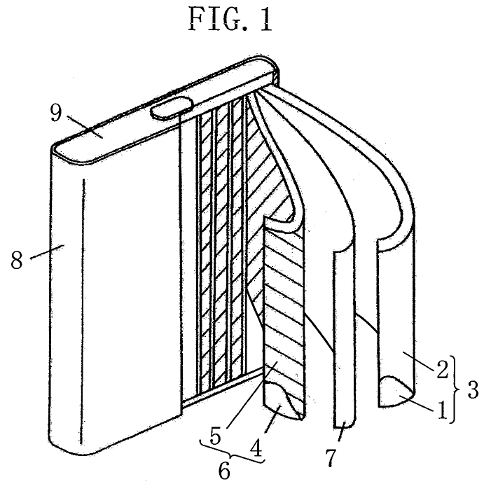

FIG. 1 is a partial cutaway perspective view schematically illustrating a configuration of a nonaqueous electrolyte secondary battery according to an embodiment of the present invention.

As shown in FIG. 1, an electrode group in which a positive electrode plate 3 including a positive electrode active material 2 formed on a positive electrode current collector 1, a negative electrode plate 6 including a negative electrode active material 5 formed on a negative electrode current collector 4 are wound into a flat shape with a separator 7 interposed therebetween is placed in a rectangular battery case 8, and the battery case 8 is sealed with a sealing plate 9.

The positive electrode plate 3 is obtained by performing, after applying a positive electrode mixture slurry containing the positive electrode active material 2 to the positive electrode current collector 1, drying the slurry and rolling the positive electrode current collector 1, heat treatment to the positive electrode current collector 1 at a predetermined temperature. The negative electrode plate 6 is obtained by forming a negative electrode active material 5 of a high capacity material such as silicon (Si), tin (Sn), and a compound of silicon (Si) or tin (Sn) on the negative electrode current collector 4.

In this case, a tensile elongation rate of the positive electrode plate 3 is larger than a tensile elongation rate of the negative electrode plate 6. As described above, the tensile elongation rate of the positive electrode plate 3 can be increased by performing, after the positive electrode current collector 1 with the positive electrode slurry applied thereto is rolled, heat treatment to the positive electrode current collector 1 at a predetermined temperature.

Note that a “tensile elongation rate” herein is the rate of elongation of a test specimen at a time when the specimen is pulled and fractured. For example, the tensile elongation rate is obtained from an elongation rate of an electrode plate whose width is 15 mm and effective part has a length of 20 mm at a time when the electrode plate is pulled at a rate of 20 mm/min and fractured.

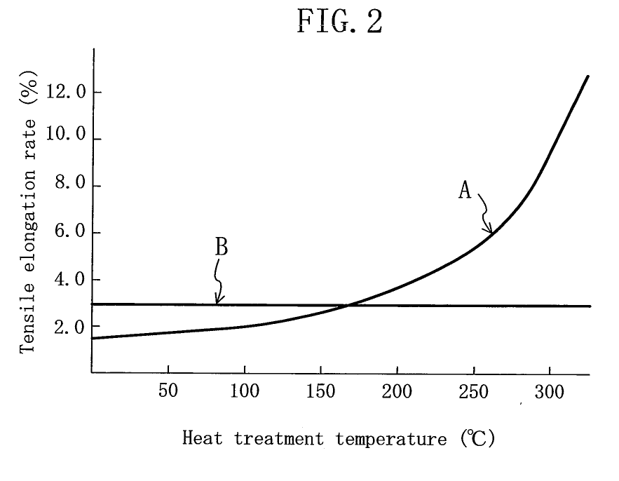

FIG. 2 is a graph showing the relationship between the heat treatment temperature and the tensile elongation rate. In FIG. 2, a curved line indicated by Arrow A represents the tensile elongation rate of the positive electrode plate 3. Note that a straight line indicated by Arrow B in FIG. 2 represents the (constant) tensile elongation rate of the negative electrode plate 6.

Each of the tensile elongation rates of the positive electrode plate 3 and the negative electrode plate 6 varies depending materials of their current collectors and active materials and process methods. As shown in FIG. 2, by setting a temperature at which heat treatment is performed to the positive electrode plate 3 to be a predetermined temperature or higher, the tensile elongation rates of the positive electrode plate 3 can be made larger than the tensile elongation rate of the negative electrode plate 6. Thus, even when a high capacity material is used as the negative electrode active material 5, following expansion/contraction of the negative electrode active material 5, the positive electrode plate 3 contracts along the length direction of the flat electrode group and thereby stress can be reduced. As a result, the occurrence of buckling deformation in a flat portion of the electrode group can be suppressed, so that a nonaqueous electrolyte secondary battery having an excellent cycle life characteristic can be realized.

To effectively suppress buckling deformation in the electrode group, the tensile elongation rate of the positive electrode plate 3 is preferably 3.0% or more. When the tensile elongation rate of the positive electrode plate 3 is larger than 10%, the positive electrode plate 3 is deformed and uniform winding can not be performed in forming the electrode group by winding the electrode plates and the separator. Therefore, the tensile elongation rate of the positive electrode plate 3 is preferably 10% or less.

To ensure a sufficiently large tensile elongation rate of the positive electrode plate 3, heat treatment is preferably performed to the positive electrode current collector 1 at a temperature of 200° C. or higher after rolling of the positive electrode current collector 1 with the positive electrode mixture slurry containing the positive electrode active material 2 which has been applied thereto and dried.

Since buckling deformation tends to occur at a time of an initial charge/discharge, the occurrence of buckling distortion in the electrode group can be more effectively suppressed by performing pressure treatment to the flat portion of the flat electrode group with a predetermined pressure or more.

For example, after the flat electrode group is placed in the rectangular battery case 8 and a battery is completed, pressure treatment can be performed to a flat, long side surface of the rectangular battery case 8 with a predetermined pressure at an initial charge/discharge before shipping. Note that to achieve sufficient effects, pressure treatment with a pressure of 1×10⁵ N/m² or more is preferably performed.

Unlike the flat electrode group, a cylindrical electrode group does not have a constricted, curved portion and, therefore, in the cylindrical electrode group, buckling deformation less frequently occurs, compared to the flat electrode group. However, when a high capacity material is used as the negative electrode active material 5, the negative electrode active material 5 largely expands/contracts and, thus, the cycle life characteristic thereof might vary according to a distance between electrode plates although buckling deformation is not caused. Therefore, even in a cylindrical electrode group, in order to reduce stress generated due to expansion/contraction of the negative electrode active material 5, the tensile elongation rate of the positive electrode plate 3 is preferably set to be larger than the tensile elongation rate of the negative electrode plate 6.

In the above-described embodiment, a high capacity material such as Si is used as the negative electrode active material 5. However, when a material (e.g., graphite or the like) having a smaller capacity than Si is used as the negative electrode active material 5, buckling deformation possibly occurs unless the tensile elongation rate of the positive electrode plate 3 is sufficiently large. Therefore, also in an electrode group using the negative electrode active material 5 of graphite or the like, the effect of suppressing the occurrence of buckling deformation in the electrode group can be exhibited by setting the tensile elongation rate of the positive electrode plate 3 to be larger than the tensile elongation rate of the negative electrode plate 6.

Next, a method for producing a nonaqueous electrolyte secondary battery according to this embodiment will be described.

A positive electrode mixture slurry containing a positive electrode active material 2 made of, for example, LiCoO₂ is applied to both surfaces of a positive electrode current collector 1 made of aluminum foil having a thickness of 15 μm and then is dried. Thereafter, the positive electrode current collector 1 is rolled so that a thickness of a positive electrode plate 3 becomes about 120 μm, and then heat treatment is performed thereto, for example, at a temperature of 280° C. for 180 seconds, thereby forming the positive electrode plate 3.

Also, a negative electrode active material 5 made of SiOₓ is deposited to a thickness of about 15 μm on both surfaces of a negative electrode current collector 4 made of copper foil having a thickness of 20 μm, for example, using vacuum vapor deposition, thereby forming a negative electrode plate 6.

Next, the positive electrode plate 3 and the negative electrode plate 6 are wound with a microporous separator 7 made of polyethylene resin having a thickness of 20 μm into an elliptical shape, thereby forming an electrode group. Thereafter, the electrode group is pressed with a pressure applied to a long side surface of the electrode group, thereby obtaining a flat electrode group.

Finally, the flat electrode group is placed in a battery case 8 having a rectangular shape with a bottom, and the battery case 8 is sealed with a sealing plate 9. Thereafter, a nonaqueous electrolyte is injected into the rectangular battery case 8 through an electrolyte injection opening formed in the sealing plate 9, and then the electrolyte injection opening is sealed using laser to complete a nonaqueous electrolyte secondary battery.

Note that in this embodiment, for components of the nonaqueous electrolyte secondary battery, the following materials, fabrication methods and the like can be used, although the material and fabrication method thereof are not particularly limited.

The positive electrode mixture slurry may contain, in addition to the positive electrode active material 2, a binder, a conducting agent and the like. The positive electrode plate 3 is formed, for example, by mixing a positive electrode mixture made of the positive electrode active material 2 and another component with a liquid component to prepare a positive electrode mixture slurry, applying the obtained slurry to the positive electrode current collector 1, and drying the slurry.

As the positive electrode active material 2, lithium composite metal oxide can be used. Examples of lithium composite metal oxide include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMePO₄, Li₂MePO₄F (M=at least one of Na, Mg, Sc, Y, Mn, Fe, Co, Ni, Cu, Zn, Al, Cr, Pb, Sb, and B). In this case, x=0 to 1.2, y=0 to 0.9, and z=2.0 to 2.3. Note that an x value representing a molar proportion of lithium is a value obtained right after an active material is formed, and is increased/decreased by charge/discharge. Furthermore, part of such a lithium containing compound may be replaced with a different element. Moreover, surface treatment may be performed to the positive electrode active material 2 using metal oxide, lithium oxide, a conducting agent or the like, and also hydrophobic treatment may be performed to a surface of the positive electrode active material 2.

As a binder of the positive electrode mixture, for example, PVDF (polyvinylidene difluoride), polytetrafluoroethylene, polyethylene, polypropylene, aramid resin, polyamide, polyimide, polyamide imide, polyacrylonitrile, polyacrylic acid, methyl ester polyacrylate, ethyl ester polyacrylate, hexyl ester polyacrylate, polymethacrylate, polymethacrylate methyl ester, polymethacrylate ethyl ester, polymethacrylate hexyl ester, polyvinyl acetate, polyvinylpyrrolidone, polyether, polyethersulfone, hexafluoropolypropylene, styrene butadiene rubber, carboxymethyl cellulose, and the like can be used. Also, a copolymer containing two or more materials selected from the group consisting of tetrafluoroethylene, hexafluoroethylene, hexafluoropolypropylene, perfluoroalkyl vinylether, vinylidene fluoride, chlorotrifluoroethylene, ethylene, propylene, pentafluoropropylene, fluoromethylvinylether, acrylic acid, and hexadiene may be used. Moreover, a mixture of two or more materials selected from the group may be also used.

As a conducting agent of the positive electrode slurry, for example, graphites including natural graphite and artificial graphite, carbon blacks including acetylene black, Ketjenblack, channel black, furnace black, lamp black, thermal black, and the like, conductive fibers including carbon fiber, metal fiber, and the like, metal powders including fluorocarbon, aluminum, and the like, conductive whiskers including zinc oxide, potassium titanate, and the like, conductive metal oxides including titanium oxide, and the like, organic conductive materials including phenylene derivative and the like, and like materials can be used.

Note that respective composition ratios of the positive electrode active material 2, the conductive agent, and the binder are preferably 80 wt % to 97 wt %, 1 wt % to 20 wt % and 1 wt % to 10 wt %, respectively.

As the positive electrode current collector 1, a conductive substrate having a porosity structure or a non-porous conductive substrate is used. For example, stainless steel, aluminum, titanium or the like is used as the positive electrode current collector 1. A thickness of the positive electrode current collector 1 is preferably within a range of 1 μm to 500 μm (more preferably 5 μtm to 20 μm) in view of reducing a weight of the positive electrode current collector 1 while maintaining strength of an electrode plate.

As the negative electrode active material 5, silicon, tin, aluminum, or a material made of a compound of silicon, tin, or aluminum. For example, assume that a compound represented by a formula of SiOx (where x is a number satisfying 0<x<2) is used. In this case, particularly when 0<x≦1, the negative electrode plate 6 having a high capacity and a long life can be realized. In this case, a value of x represents a ratio of oxygen content to the entire negative electrode active material 5 and can be obtained, for example, based on a determinate quantity of oxygen obtained by a combustion method. The compound may be a SiOx aggregate locally having a plurality of different SiOx compositions, or a SiOx aggregate having a perfectly uniform composition.

The negative electrode active material 5 is formed on the negative electrode current collector 4 by forming a deposited film using a physical method such as sputtering, vacuum vapor deposition, spraying, shot-peening treatment, and the like, or a chemical method such as CVD, plating or the like. As another option, the negative electrode active material 5 may be formed by forming a sintered film by applying a negative electrode mixture slurry to the negative electrode current collector 4 and then drying the slurry.

Among the above-described methods, specifically, vacuum vapor deposition is preferable because it allows high speed deposition of a deposited film with a thickness in a range of several μm to 50 μm. Note that a deposited film does not have to be flat and smooth, but may include precipitates of a deposited active material in a pillar or island shape. Moreover, in a method in which a sintered film is formed, it is preferable that a mixture layer containing the negative electrode active material 5 is first formed and then sintering process is performed to the mixture layer by heating or plasma processing to form a sintered film.

When a deposited film or a sintered film as the negative electrode active material 5 is formed of elemental Si, the deposited film or the sintered film preferably has a thickness in a range of 1 μm to 20 μm. With a film having a smaller thickness than 1 μm, a volume of the negative electrode current collector 4 in a battery is too large, and thus it is difficult to obtain a high capacity battery. With a film having a larger thickness than 20 μm, stress generated due to expansion/contraction of the negative electrode active material 5 might damage the entire negative electrode current collector 4 or the entire negative electrode plate 6. From the same view point, when the deposited film or the sintered film of the negative electrode active material 5 is formed of alloy containing Si or a compound containing Si, the deposited film or the sintered film preferably has a thickness in a range of 3 μm to 50 μm. Note that the above-described film thickness is the thickness of the deposited film or the sintered film before lithium is inserted thereto and is substantially equal to the thickness of the deposited film or the sintered film in a discharged state (where the battery has been discharged to a cut-off voltage of discharge).

Note that as the negative electrode active material 5, in addition to the above-described high capacity materials, carbon materials such as graphite, carbon fiber and the like can be also used.

As a binder of the negative electrode mixture slurry, any material which has adhesive force for bonding the negative electrode current collector 4 and the negative electrode active material 5 and is electrochemically inactive in a potential range in which a battery is operated may be used. For example, styrene-butylene copolymer rubber, polyacrylic acid, polyethylene, polyurethane, polymethacrylate methyl, polyvinylidene fluoride, polytetrafluoroethylene, carboxymethyl cellulose, methyl cellulose, and the like are suitable as a binder. Any one of the above-described materials may be independently used or combination of two or more of the above-described materials may be used. In view of maintaining the configuration of negative electrode mixture layer, it is more preferable to add a large amount of a binder. However, in view of improving the battery capacity and discharge property, it is more preferable to add a small amount of a binder. Moreover, it is preferable that the negative electrode mixture layer further includes a conducting agent containing, as a major component, carbon represented by graphite, carbon black, carbon nano tube, and the like. The conducting agent is preferably in contact with the negative electrode active material 5.

As the negative electrode current collector 4, copper foil or copper alloy foil is preferably used. Copper alloy foil containing 90 wt % or more copper is preferable. In view of improving the strength or bendability of the negative electrode current collector 4, it is effective that the copper foil or the copper alloy foil contains P, Ag, Cr or like element.

The negative electrode current collector 4 preferably has a thickness in a range of 6 μm to 40 μm. If the negative electrode current collector 4 has a smaller thickness than 6 μm, it is difficult to handle the negative electrode current collector 4 and also it is difficult to maintain necessary strength of the negative electrode current collector 4, so that the negative electrode current collector 4 might be cut or wrinkled due to expansion/contraction of the negative electrode active material 5. When the negative electrode current collector 4 has a larger thickness than 40 μm, the volume ratio of the negative electrode current collector 4 to the entire battery becomes too large and, depending on the type of battery, this causes disadvantages in terms of capacity. Moreover, the negative electrode current collector 4 having a large thickness is difficult to bend and handle.

As the separator 7, microporous film, woven cloth, nonwoven cloth or the like which has a large ion permeation rate, predetermined mechanical strength and insulation property is used. As a material suitable for the separator 7, for example, polyolefin, such as polypropylene, polyethylene and the like is preferable in view of safety of a nonaqueous electrolyte secondary battery, because it has excellent durability and the shut-down function. The separator 7 preferably has a thickness within a range of 10 μm to 40 μm (more preferably 10 μm to 25 μm). Furthermore, a microporous film may be a single-layer film made of a single material, or may be a composite film or a multilayer film made of a single material, or two or more materials. The porosity of the separator 7 is preferably within a range of 30% to 70% (more preferably 35% to 60%).

As the nonaqueous electrolyte, a liquid, gel or solid (polymer solid electrolyte) material can be used. A liquid nonaqueous electrolyte (nonaqueous electrolytic solution) is obtained by dissolving an electrolyte (e.g., lithium salt) in a nonaqueous solvent. A gel nonaqueous electrolyte contains a nonaqueous electrolyte and a polymer material in which the nonaqueous electrolyte is held. As the polymer material, for example, polyvinylidene fluoride, polyacrylonitrile, polyethylene oxide, polyvinyl chloride, polyacrylate, polyvinylidene fluoride hexafluoropropylene, or the like is preferably used.

As a nonaqueous solvent in which an electrolyte is dissolved, a known nonaqueous solvent can be used. The type of the nonaqueous solvent is not particularly limited but, for example, cyclic carbonate ester, chain carbonate ester, cyclic carboxylate ester, or the like lo is used. Cyclic carbonate esters include propylene carbonate (PC), ethylene carbonate (EC), and the like. Chain carbonate esters include diethyl carbonate (DEC), ethyl methyl carbonate (EMC), dimethyl carbonate (DMC), and the like. Cyclic carboxylate esters include γ-butyrolactone (GBL), γ-valerolactone (GVL), and the like. As the nonaqueous solvent, a single nonaqueous solvent may be independently used, or a combination of two or more nonaqueous solvents may be used.

As an electrolyte to be dissolved in a nonaqueous solvent, for example, LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borate, imid salt, or the like can be used. Borates include bis(1,2-benzenediolate(2-)-O,O′)lithium borate, bis(2,3-nafthalanediorate(2-)-O,O′)lithium borate, bis(2,2′-biphenyldiolate(2-)-O,O′)lithium borate, bis(5-fluoro-2-olate-1-benzenesulfonic acid-O,O′)lithium borate, and the like. Imide salts include lithium bistrifluoromethane sulfonimide((CF₃SO₂)₂NLi), lithium trifluoromethane sulfonic acid nonafluorobutane sulfonimide(LiN(CF₃SO₂)(C₄F₉SO₂)), lithium bispentafluoroethane sulfonimide((C₂F₅SO₂)₂NLi), and the like. As the electrolyte, a single electrolyte may be independently used, or a combination of two or more electrolytes may be used.

The nonaqueous electrolytic solution may contain as an additive a material which is decomposed on a negative electrode plate to form a coating film having a high lithium ion conductivity and can increase a charge/discharge efficiency of a battery. Additives having this function include, for example, vinylene carbonate (VC), 4-methylvinylene carbonate, 4,5-dimethylvinylene carbonate, 4-ethylvinylene carbonate, 4,5-dimethylvinylene carbonate, 4-propylevinylene carbonate, 4,5-dipropylenevinylene carbonate, 4,5-phenylvinylene carbonate, 4,5-diphenylvinylene carbonate, vinyl ethylene carbonate (VEC), divinyl ethylene carbonate, and the like. Any one of the above-described compounds may be independently used, or a combination of two or more of the above-described compounds may be used. Of the above-described compounds, at least one selected from the group consisting of vinylene carbonate, vinyl ethylene carbonate and divinyl ethylene carbonate is preferably contained in the additive. Note that some of hydrogen atoms of each of the above-described compounds may be substituted with fluorine atoms. The amount of the dissolved electrolyte with respect to the nonaqueous electrolytic solution is preferably within a range of 0.5 mol/L to 2 mol/L.

Furthermore, the nonaqueous electrolyte may contain a known benzene derivative which is decomposed to form a coating film on electrodes at a time of overcharge and thus deactivates a battery. As the benzene derivative, a benzene derivative including a phenyl group or a benzene derivative including a cyclic compound group adjacent to a phenyl group is preferable. As the cyclic compound group, a phenyl group, a cyclic ether group, a cyclic ester group, a cycloalkyl group, a phenoxy group or the like is preferable. Specific examples of the benzene derivative include cyclohexyl benzene, biphenyl, diphenyl ether, and the like. Any one of these derivatives may be independently used, or a combination of two or more of these derivatives may be used. A content of the benzene derivative in the nonaqueous solvent is preferably 10 vol % or less of the entire nonaqueous solvent.

Hereinafter, a configuration and effects of a nonaqueous electrolyte secondary battery according to the disclosure of the present invention will be further described using examples of the present invention. The present invention is not limited to the following examples.

Nonaqueous electrolyte secondary batteries having a configuration of FIG. 1 were formed in the following manner and cycle life property of each of the batteries was evaluated.

(1) Formation of Negative Electrode Plate

A graphite crucible in which metal Si (ingot with a purity of 99.999%, manufactured by Furuchi Chemical) was put and an electron gun were set in a vacuum vapor deposition system. Electrolytic copper foil (having a thickness of 20 μm, manufactured by Furukawa Circuit Foil) to serve as the negative electrode current collector 4 was introduced to the vacuum vapor deposition system from a roll at constant speed (5 cm/min), and a SiOₓ film was deposited to a surface of the electrolytic copper foil in a state where the copper foil was heated to 400° C. while oxygen gas (manufactured by Nippon Sanso) with a purity of 99.7% was supplied at a flow rate of 80 sccm. Deposition was performed in this case under the condition that the degree of vacuum was 3×10⁻⁶ Torr, an accelerating voltage was −8 kV, and a current was 150 mA.

After vapor deposition to one surface of the negative electrode current collector 4 was completed, vacuum vapor deposition was further performed to a back surface thereof (to which the SiOₓ film had not been deposited yet) in the same manner, thereby forming an active material thin film 5 of SiOₓ with a thickness of 15 μm on each of both surfaces of the negative electrode current collector 4. Thus, a negative electrode plate 6 was obtained.

Note that in order to insert lithium in the active material thin film 5 in advance, after the active material thin film 5 was formed, the negative electrode current collector 4 was introduced into the vacuum vapor deposition system again to deposit Li on the active material thin film 5 from a metal Li target (manufactured by Honjo Chemical) by resistance heating. A deposition amount was adjusted by changing moving speed of the electrode current collector 4 to be introduced into the vacuum vapor deposition system from the roll. When the moving speed of the electrode current collector 4 was 5 cm/min, the thickness of deposited Li was about 5 μm.

Note that after the SiOₓ thin film was formed on each of the both surfaces of the electrode current collector 4, the electrode current collector 4 was once placed at 110° C. and dried for 15 hours in vacuum and then, was stored in a dry atmosphere whose dew point was −60° C. or less at room temperature. Also, after Li was deposited, moisture in an electrode was removed or managed by storing the electrode current collector 4 in a dry atmosphere whose dew point was −60° C. or less in the same manner.

(2) Formation of Positive Electrode Plate

LiCoO₂ as a positive electrode active material was synthesized by mixing Li₂CO₃ and CoCO₃ at a predetermined molar ratio and heating the obtained mixture at 950° C. Obtained LiCoO₂ was classified to obtain particles with a size of 45 μm or smaller. Five parts by weight of acetylene black as a conducting agent, 4 parts by weight of polyvinylidene fluoride as a binder and an appropriate amount of N-methyl-2-pyrrolidone as a dispersion medium were added to 100 parts by weight of the positive electrode active material and then they all were mixed well, thereby obtaining a positive electrode mixture slurry.

The positive electrode mixture slurry was applied to both surfaces of a current collector 1 of aluminum foil (manufactured by Showa Denko) with a thickness of 15 μm and dried, and then the current collector 1 with the positive electrode mixture slurry applied thereto was rolled, thereby obtaining a positive electrode plate 3. After rolling, the positive electrode plate 3 was subjected to heat treatment at a predetermined temperature for a predetermined time to adjust a tensile elongation rate of the positive electrode plate 3.

The positive electrode plate 3 was stored in a dry atmosphere whose dew point was −60° C. or less at room temperature, and an electrode was dried at 80° C. in vacuum to dewater just before assembling a battery according to the step described below.

(3) Formation of Nonaqueous Electrolyte

As a nonaqueous electrolyte, an electrolyte obtained by dissolving lithium hexafluorophosphate at a concentration of 1 mol/L in a nonaqueous solvent obtained by mixing ethylene carbonate and diethyl carbonate at a volume ratio of 1:1 was used.

(4) Formation of Battery

An aluminum positive electrode lead and a nickel negative electrode lead were respectively connected to the respective current collectors 1 and 4 of the positive electrode plate 3 and the negative electrode plate 6, and then the positive electrode plate 3 and the negative electrode plate 6 were wound into an elliptical shape with a microporous separator 7 of polyethylene resin with a thickness of 20 μm interposed therebetween to form an electrode group. The electrode group was pressed by applying a pressure of 6.5 MPa to a long side surface of the electrode group for 5 seconds, thereby obtaining a flat electrode group.

The flat electrode group was placed in a battery case 8 made of 3000-series aluminum alloy containing an extremely small amount of metal such as manganese, copper or the like, formed by press-molding into a rectangular shape with a bottom, and having a thickness of 0.25 mm, a width of 6.3 mm, a length of 34.0 mm and a total height of 50.0 mm.

Thereafter, the electrode group in the battery case 8 was dried in an atmosphere whose dew point was −30° C. at a temperature of 90° C. for 2 hours, so that the amount of moisture contained in the electrode group was reduced from 500 ppm to 70 ppm.

Furthermore, after a sealing plate 9 and the battery case 8 were laser-welded together, a nonaqueous electrolyte was injected into the rectangular battery case 8 through an injection hole provided in the sealing plate 9, and then an injection plug was sealed by laser. Thus, a rectangular battery was formed. Note that a design capacity of the obtained battery was 1000 mAh (hereinafter, referred to as “1 ItA (one-hour rate current)”.

(5) Measurement of Tensile Elongation Rate for Positive Electrode Plate and Negative Electrode Plate

The battery was decomposed and the positive electrode plate 3 and the negative electrode plate 6 were taken out from the battery. Test specimens having a width of 15 mm and an effective length of 20 mm were cut out from the positive electrode plate 3 and the negative electrode plate 6. The test specimens were pulled at a speed of 20 mm/min and an elongation rate was measured for each of the test specimens at a time when each of the test specimens was fractured. The measured elongation rate was regarded as a tensile elongation rate.

(6) Evaluation of Cycle Life Property

In a constant temperature reservoir with temperature set at 20° C., the battery was charged with a constant current of 1 ItA until a battery voltage reached 4.05 V, the battery was charged with a voltage of 4.05 V until a current value reached 0.05 ItA, and then the battery was discharged with a constant current of 1 ItA until the battery voltage was reduced to 2.5 V. The above-described series of charge and discharge operations was repeated. Then, the ratio of the discharge capacity at the 100^{th} cycle to the discharge capacity at the second cycle was obtained. This ratio was a capacity maintenance rate (%).

Table 1 shows results obtained from evaluations of the capacity maintenance rate after 100 cycles which were conducted to batteries respectively including positive electrodes 3 subjected to heat treatment at different heating temperatures within a range of 120° C. to 320° C. after rolling of the positive electrode plates 3. Note that a heat treatment time was 180 seconds.

TABLE 1

| | | | Tensile | |
|---|---|---|---|---|
| | | Tensile | elongation | |
| | Heat treatment | elongation | rate of | Capacity |
| | temperature | rate of | positive | maintenance |
| | for positive | negative | electrode | rate after 100 |
| | electrode (° C.) | electrode (%) | (%) | cycles (%) |
| Example 1 | 320 | 3.1 | 12.2 | 92.3 |
| Example 2 | 280 | | 6.8 | 94.4 |
| Example 3 | 240 | | 4.9 | 91.7 |
| Example 4 | 200 | | 4.1 | 89.1 |
| Comparative | 160 | | 2.8 | 79.1 |
| Example 1 | | | | |
| Comparative | 120 | | 2.3 | 77.0 |
| Example 2 | | | | |
| Comparative | Not | | 1.7 | 76.6 |
| Example 3 | performed | | | |

As shown in Table 1, as the heat treatment temperature increases, the tensile elongation rate of the positive electrode plate 3 increases. It is also shown that in the batteries (Examples 1 through 4) each of which has a positive electrode exhibiting a larger lo tensile elongation rate than a tensile elongation rate (3.1%) of a negative electrode, the capacity maintenance rate after 100 cycles is high and, on the other hand, in the batteries (Comparative Examples 1 through 3) each of which has a positive electrode plate exhibiting a smaller tensile elongation rate than a tensile elongation rate of a negative electrode plate, the capacity maintenance rate after 100 cycles is low.

The reason for this is considered that following expansion/contraction of the negative electrode active material 5, the positive electrode plate 3 exhibiting a large tensile elongation rate expanded/contracted along a length direction of the flat electrode group, thus reducing stress. As a result, the occurrence of buckling deformation in a flat portion of the electrode group was suppressed, and thus a battery having excellent cycle life property was obtained.

Note that in the battery (Example 1) in which heat treatment was performed at a temperature of 320° C., the capacity maintenance rate was reduced a little. The reason for this is considered that the tensile elongation rate of the positive electrode plate was too large (12.2%), and thus uniform winding was not ensured in the step of forming the electrode group, thus resulting in a location shift.

In the battery (Comparative Example 3) including the positive electrode plate which was not subjected to heat treatment after rolling thereof, the occurrence of buckling deformation was observed in the flat portion of the electrode group.

Based on the results of Table 1, for the above-described examples, the temperature at which heat treatment is performed to the positive electrode plate after rolling thereof is is preferably 200° C. or more. However, for example, when the negative electrode active material is formed by vacuum vapor deposition, the tensile elongation rate of the negative electrode plate varies also according to the temperature to which the negative electrode current collector is heated in vapor deposition. In the examples, the negative electrode current collector (copper foil) was heated to 400° C. and then vapor deposition was performed. However, for example, when the heating temperature during vapor deposition is 300° C., the tensile elongation rate of the negative electrode plate is about 1.4%. Accordingly, in this case, even when the temperature to which the positive electrode plate is heated after rolling thereof is 200° C. or less, the tensile elongation rate of the positive electrode plate can be made larger than the tensile elongation rate of the negative electrode plate.

Table 2 shows results obtained from evaluations of the capacity maintenance rate after 100 cycles which were conducted to batteries respectively including the positive electrodes 3 subjected to heat treatment at a fixed heating temperature of 280° C. for different heat treatment times within a range of 30 seconds to 240 seconds after rolling of the positive electrode plates 3.

TABLE 2

| | | | Tensile | |
|---|---|---|---|---|
| | Heat | Tensile | elongation | |
| | treatment | elongation | rate | Capacity |
| | time for | rate of | of positive | maintenance |
| | positive | negative | electrode | rate after 100 |
| | electrode (s) | electrode (%) | (%) | cycles (%) |
| Example 5 | 240 | 3.1 | 10.6 | 93.0 |
| Example 6 | 180 | | 6.8 | 94.4 |
| Example 7 | 120 | | 5.2 | 90.6 |
| Example 8 | 60 | | 4.0 | 89.1 |
| Example 9 | 30 | | 3.2 | 84.6 |
| Comparative | Not | | 1.7 | 76.6 |
| Example 4 | performed | | | |

As shown in Table 2, as the heat treatment time increases, the tensile elongation rate of the positive electrode plate 3 increases. It is also shown that in the batteries (Examples 5 through 9) each of which has a positive electrode exhibiting a larger tensile elongation rate than a tensile elongation rate (3.1%) of a negative electrode, the capacity maintenance rate after 100 cycles is high and, on the other hand, in the battery (Comparative Example 4) which has a positive electrode plate exhibiting a smaller tensile elongation rate than a tensile elongation rate of a negative electrode plate, the capacity maintenance rate after 100 cycles is low.

Table 3 shows results obtained from evaluations of the capacity maintenance rate after 100 cycles which were conducted to batteries respectively including flat electrode groups with flat surface portions subjected to pressure treatment with different pressures within a range of 0.5×10⁵ N/m² to 8.0×10⁵ N/m² at an initial charge/discharge.

TABLE 3

| | Pressure | Capacity |
|---|---|---|
| | applied at | maintenance |
| | initial charge/ | rate after 100 |
| | discharge (N/m²) | cycles (%) |
| Example 10 | 8.0 × 10⁵ | 94.4 |
| Example 11 | 4.0 × 10⁵ | 94.3 |
| Example 12 | 2.0 × 10⁵ | 94.4 |
| Example 13 | 1.0 × 10⁵ | 94.4 |
| Example 14 | 0.5 × 10⁵ | 85.0 |
| Comparative | Not | 81.2 |
| Example 5 | performed | |

As shown in Table 3, in the batteries (Examples 10 through 14) to which pressure treatment was performed at an initial charge/discharge, the capacity of maintenance rate after 100 cycles is improved, compared to the battery (Comparative Example 5) to which pressure treatment was not performed. The reason for this is considered that the occurrence of buckling deformation in the electrode group which would frequently occur at lo an initial charge/discharge operation was suppressed by performing pressure treatment to the flat surface portions of the flat electrode groups.

Note that to achieve sufficient effects, a pressure to be applied in pressure treatment is preferably 1.0×10⁵ N/m² or more. Also, if the pressure is set to be 2.0×10⁵ N/m² or more, a significant difference can not be made.

What is claimed is:

1. A nonaqueous electrolyte secondary battery comprising an electrode group in which a positive electrode plate including a positive electrode active material formed on a positive electrode current collector and a negative electrode plate including a negative electrode active material formed on a negative electrode current collector are wound with a separator interposed therebetween,
wherein a tensile elongation rate of the positive electrode plate is larger than a tensile elongation rate of the negative electrode plate.

2. The nonaqueous electrolyte secondary battery of claim 1, wherein the tensile elongation rate of the positive electrode plate is within a range of 3% to 10%.

3. The nonaqueous electrolyte secondary battery of claim 1, wherein after the positive electrode current collector with a positive electrode mixture slurry containing the positive electrode active material, applied thereto and dried is rolled, the positive electrode plate is subjected to heat treatment at a predetermined temperature.

4. The nonaqueous electrolyte secondary battery of claim 3, wherein the predetermined temperature is 200° C. or more.

5. The nonaqueous electrolyte secondary battery of claim 1, wherein the negative electrode active material is formed of silicon, tin or a compound of silicon or tin.

6. The nonaqueous electrolyte secondary battery of claim 1, wherein the electrode group is wound into a flat shape and is placed in a rectangular battery case.

7. The nonaqueous electrolyte secondary battery of claim 6, wherein a flat portion of the flat electrode group is subjected to pressure treatment with a pressure of 1×10⁵ N/m² or more at least at a time of an initial charge/discharge.

8. A method for producing a nonaqueous electrolyte secondary battery comprising an electrode group in which a positive electrode plate including a positive electrode active material formed on a positive electrode current collector and a negative electrode plate including a negative electrode active material formed on a negative electrode current collector are wound with a separator interposed therebetween,
wherein the positive electrode plate is formed by the steps of:
applying a positive electrode mixture slurry containing a positive electrode active material to the positive electrode current collector and drying the slurry;
rolling the positive electrode current collector with the positive electrode mixture slurry applied thereto and dried; and
performing heat treatment to the rolled positive electrode current collector at a predetermined temperature, and
a tensile elongation rate of the positive electrode plate is larger than a tensile elongation rate of the negative electrode plate.

9. The method of claim 8, wherein in the step of performing heat treatment, the rolled positive electrode current collector is subjected to heat treatment at a temperature of 200° C. or more.

10. The method of claim 8, wherein the electrode group is wound into a flat shape and is placed in a rectangular battery case.
